(19) United States
(12) Patent Application Publication
(10) Pub. No.: US 2014/0199446 A1
(43) Pub. Date: Jul. 17, 2014

(54) Split-Belt Conveyor Toaster

(71) Applicant: STAR MANUFACTURING INTERNATIONAL, INC., St. Louis, MO (US)

(72) Inventor: Michael L. Huegerich, St. Louis, MO (US)

(73) Assignee: STAR MANUFACTURING INTERNATIONAL, INC., St. Louis, MO (US)

(21) Appl. No.: 14/153,228

(22) Filed: Jan. 13, 2014

Related U.S. Application Data
(60) Provisional application No. 61/751,592, filed on Jan. 11, 2013.

(51) Int. Cl. A47J 37/04; A23L 1/01

(52) U.S. Cl. CPC A47J 37/044; A23L 1/0128
USPC 426/233; 99/386

(57) ABSTRACT

A conveyor toaster includes a housing with a split-conveyor extending through the housing to convey food items through a cooking chamber for cooking by infrared heating elements located above and below the conveyor. Electrical components are separated from the heating elements and cooled with ambient air.

### CROSS-REFERENCE TO RELATED APPLICATIONS

This non-provisional application claims priority to U.S. provisional application Ser. No. 61/751,592 filed Jan. 11, 2013, and which is incorporated herein by reference.

### STATEMENT REGARDING FEDERALLY SPONSORED RESEARCH

Not applicable.

### BACKGROUND

The invention relates to the field of conveyor toasters, and more particularly, to an infrared conveyor toaster with a single or split conveyor with corresponding process controls.

Conveyor toasters can provide fast and even toasting and cooking of food items. Typically, conveyor toasters heat food items with radiant or infrared heat, to toast or cook food items as they pass through a cooking chamber. In addition, conveyor toasters may use convection or forced impingement convection, by directing jets of heated air onto food items, such as, bread and sandwiches, as they pass through a cooking chamber of the oven on the conveyor. A blower, and convection heating elements, heat and circulate air to the cooking chamber from a separate circulation duct.

While conveyor toasters have proven to be an effective and valuable cooking device, they are limited to operation at a single cooking condition having a single temperature and a single conveyor speed. This limits variety of items that can be cooked within the oven at a given time. For example, some food items, such as bread, may require a predetermined temperature and conveyor speed, while other food items, such as pizza, may require a different temperature and conveyor speed.

Therefore, a conveyor toaster with multiple cooking conditions and better process control is needed.

### DESCRIPTION OF THE DRAWINGS

In the accompanying drawings which form part of the specification:

FIG. 1 is an orthogonal projection of an conveyor toaster;

FIG. 2 is a top view of the conveyor toaster;

FIG. 3 is a side view of the conveyor toaster;

FIG. 4 is a front view of the conveyor toaster; and

FIG. 5 shows a cross-section view of the conveyor toaster along line A-A of FIG. 1;

FIG. 6 shows a cross-section view of the conveyor toaster along line A-A of FIG. 1 and a diagram of the airflow within the conveyor toaster;

FIG. 7 is a orthogonal projection view of a paddle;

FIG. 8 is a top view of the paddle; and

FIG. 9 is a side view of the paddle.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the claimed invention, describes several embodiments, adaptations, variations, alternatives, and uses of the claimed invention, including what is presently believed to be the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

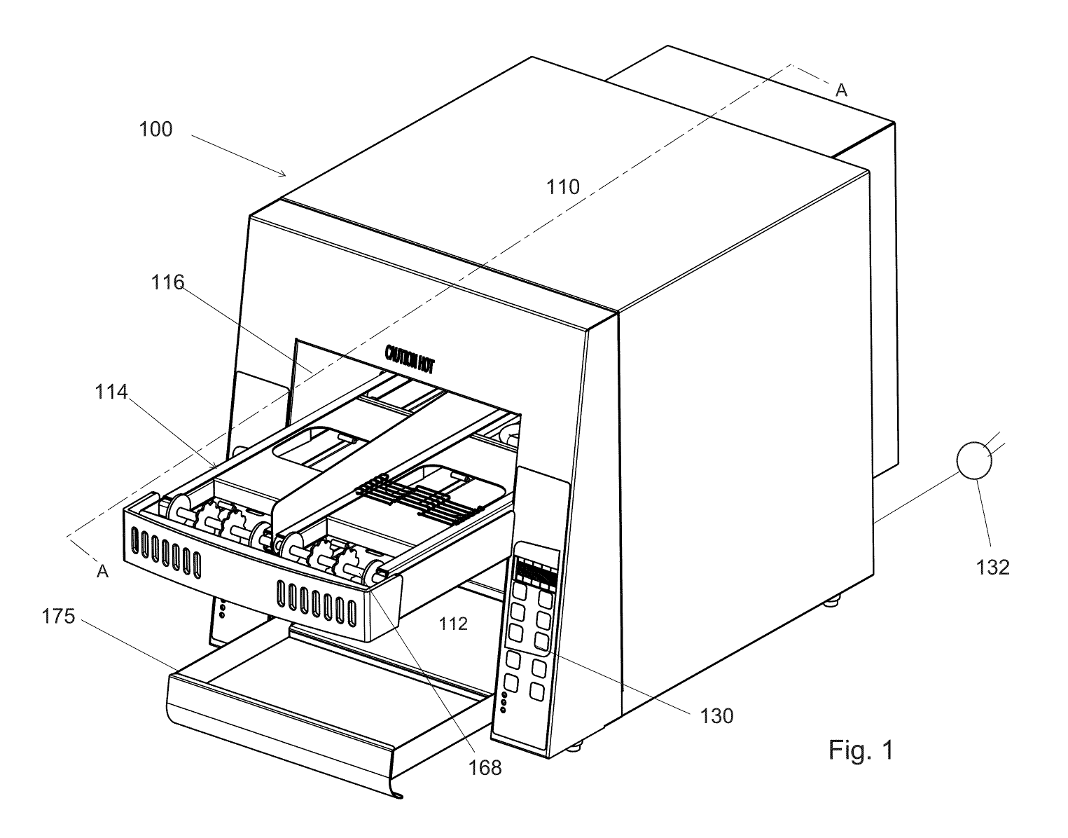

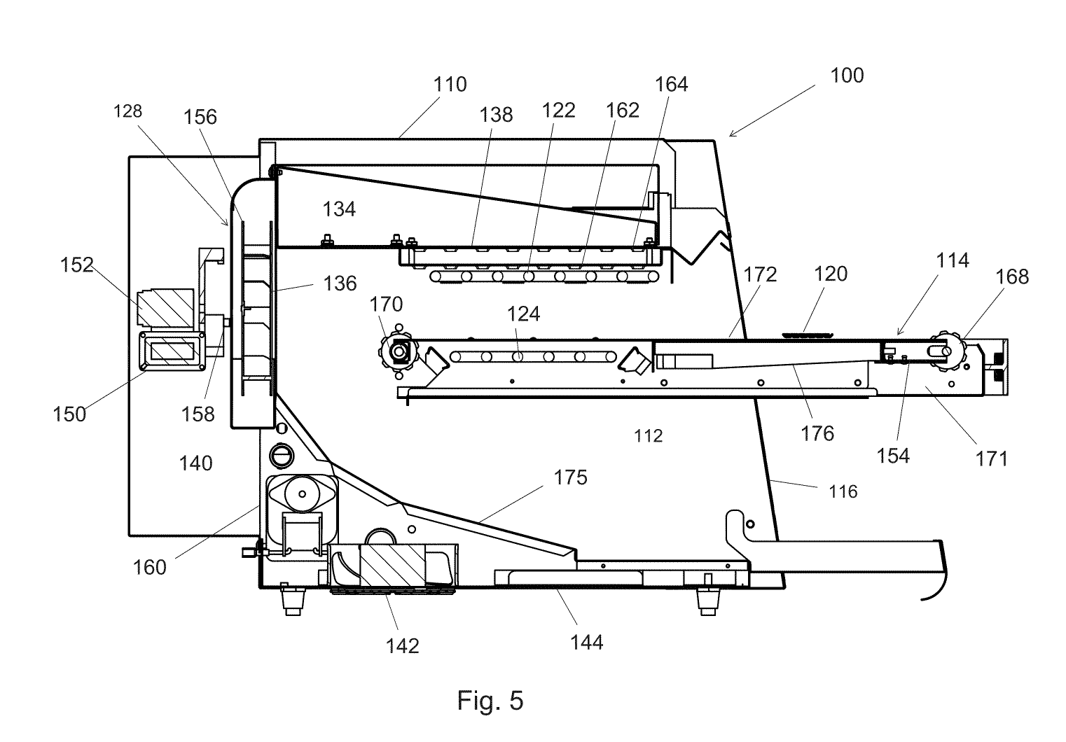

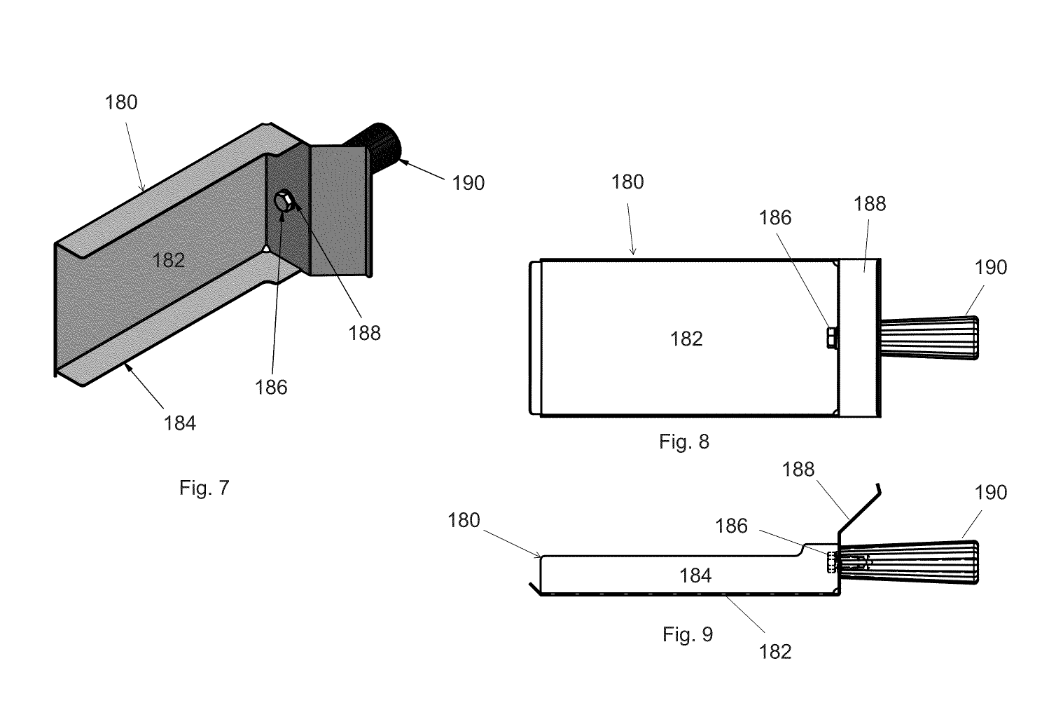

As shown in FIGS. 1-9, a conveyor toaster 100, includes a housing 110 defining a cooking chamber 112, and a dual or split conveyors 114 extending from the cooking chamber 112 through an opening 116. The conveyors 114 convey food items 120 through the cooking chamber 112 for cooking by radiant heating elements 122 and 124 located above and below the conveyor 114 (FIG. 5). A blower assembly 128 located within the housing 110, circulates air heated by the heating elements 122 and 124 within the cooking chamber 112 to enhance cooking of the food items 120 by convection, or more specifically by forced impingement convection (FIG. 5). A control panel 130 positioned on the exterior of the housing 110 operatively connects to the heating elements 122 and 124, to the conveyors 114, to the blower assembly 128, and to a power supply 132 (FIG. 1). An operator engages the control panel 130 to select the desired operating settings of the oven 100. Each of the elements 122 and 124, the conveyors 114, and the blower assembly 128 are independently adjustable to provide a plurality of cooking conditions simultaneously within the cooking chamber 112. For example, the conveyors 114 can operate at different speeds to expose different food products different amounts of thermal exposure within the cooking chamber 112. If needed, the operator can use a paddle 180 to place and remove food items from the conveyors 114 (FIGS. 7-9).

Although, the embodiment of FIGS. 1-6 disclose a split conveyor, those skilled in the art will recognize that a single conveyor can also be used. In addition, more than two conveyors can also be used.

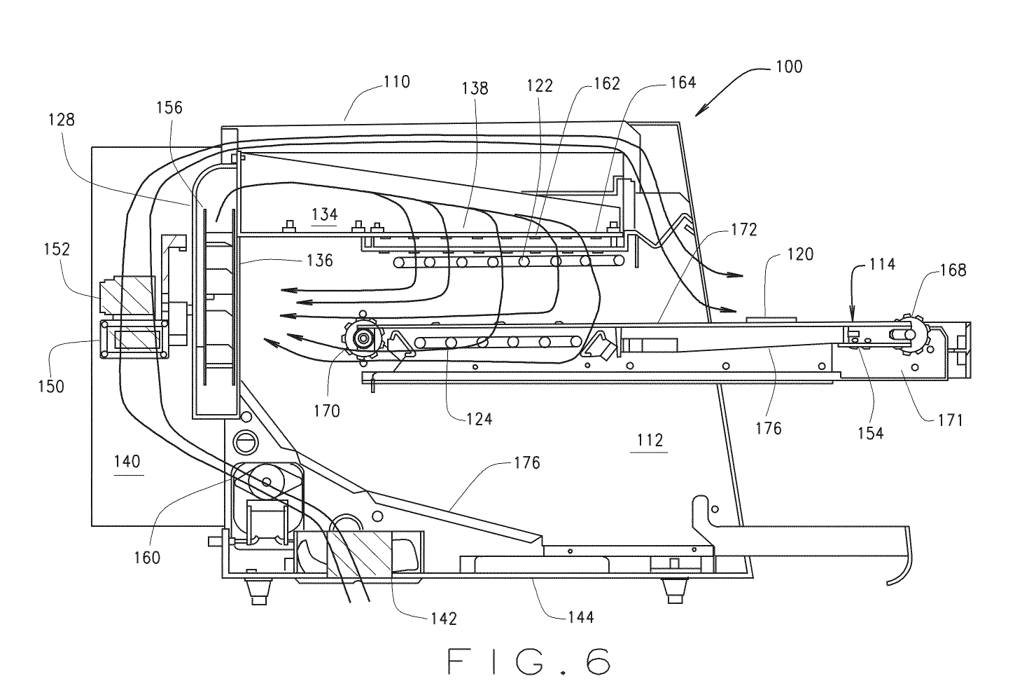

The housing 110 also defines a circulation duct 134 in communication with the cooking chamber 112 through inlet 136 at the rear portion of the cooking chamber 112 and an outlet 138 at the upper portion of the cooking chamber 112 (FIGS. 5-6). Together, the circulation duct 134 and the cooking chamber 112 form a continuous loop (generally a circular path) for the air to travel around. A cooling channel 140 draws in ambient air through inlets 142 at the bottom 144 of the housing 110, and communicates the air through the rear controls chamber area 148 through an upper cooling channel 147 to the opening 116 (FIGS. 5-6). The ambient air cools the various equipment housed within the controls chamber 148, such as electronics 150, and the blower motor 52. In turn, the ambient air warms and impinges on the food items at the opening to dry and pre-toast the food items.

The blower assembly 128 includes a fan 156 positioned within the circulation duct 134. (FIG. 4). The fan 156 connects to the blower motor 152 positioned within the controls chamber 148 to insulate the blower motor 152 from the heated air in the circulation duct 134. A motor shaft 158 extends from the blower motor 152 through an inner wall 160 to engage with the fan 156. The blower motor 152 operatively connects to the control panel 130. In operation, the blower motor 152 rotates the fan 156, which draws air from the cooking chamber 112 through the inlet 136 and forces the air through the outlet 138 to impingement panels 162. The impingement panels 162 are mounted above the conveyor 114. A plurality of apertures 164 evenly spaced about the impingement panels 162 direct air flow downwardly at increased speed towards the conveyor 114 to impinge the food items 120 (FIG. 5). The acceleration of the air flow is caused by the constriction of air as it passes through the apertures 164, which produces a pressure rise on the upwind side of the apertures 164 and a pressure drop of the downwind side of the apertures 164 as the air diverges. This phenomenon is oftentimes referred to as the Venturi effect.

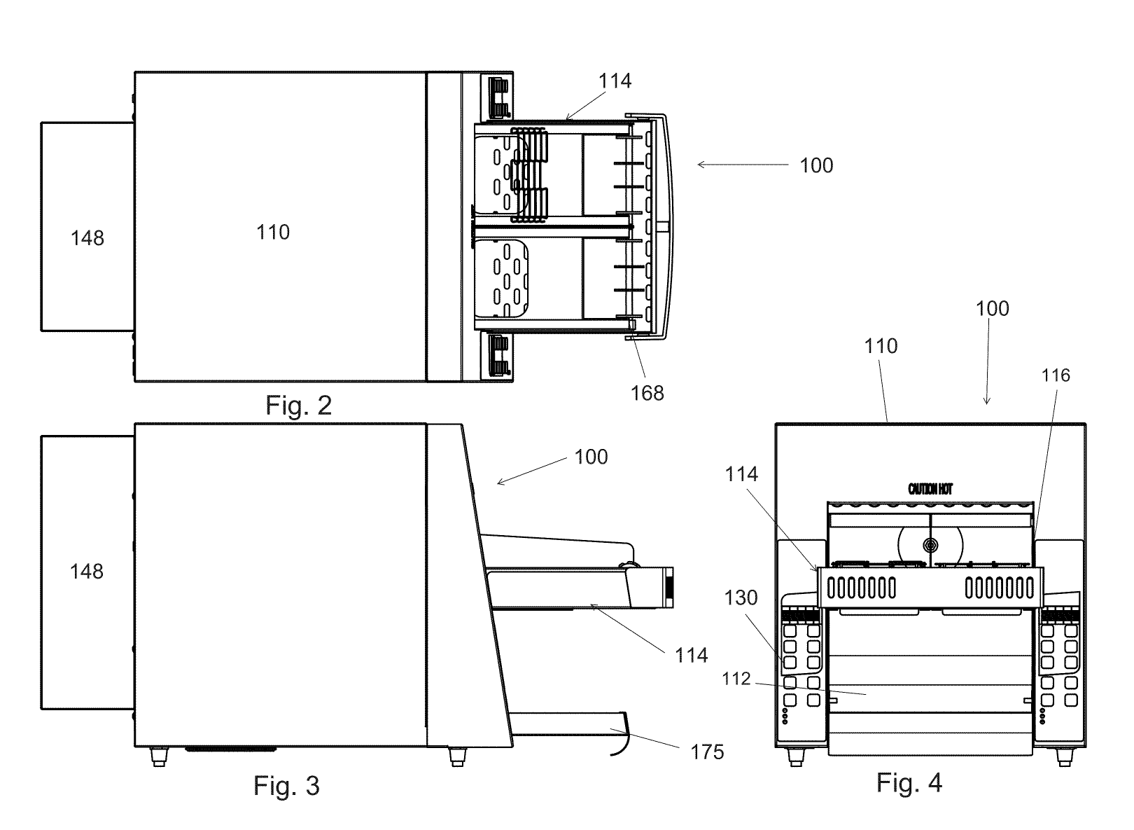

Upper and lower infrared heating elements 122 and 124, are located within the cooking chamber 112 above and below the conveyor 114 and adjacent the impingement panels 162 (FIGS. 2-3). In an alternate embodiment, reflectors are mounted above the upper infrared heating elements 122 to reflect infrared energy from the upper elements 122 towards the conveyor 114. Therefore, the reflectors increase the efficiency of the upper elements 122 by focusing the resultant infrared energy downwardly towards the conveyor 114. Moreover, infrared energy not reflected towards the conveyor 114 by the reflectors from the upper elements 122 is used to heat the air flow moving from the circulation duct 134 to the impingement panels 162. Preferably, each reflector is an elongated metal tray with a generally U-shaped cross-section. However, other size, shapes, and materials can be used.

Locating infrared heating elements 122 and 124 both above and below the conveyor 114 permits toasting of both the top and bottom of food items 120, as well as resulting in an overall faster cooking time. Although, the infrared heating elements 122 and 124 primarily emit infrared or radiant energy to the food items 120, some energy conducts with the air, thereby, raising the temperature of the air flow for convection cooking. In FIGS. 2-3, the infrared heating elements 122 and 124 are preferably quartz infrared heaters. However, those skilled in the art will recognize that other types of infrared heating elements can be used that emit long medium wavelength or short wavelength infrared energy, such as gas, metal sheathed, ceramic, or gas infrared heaters.

Each conveyor 114 includes a pair of parallel rollers 168 and 170 mounted to the housing 110 within the cooking chamber 112 and extending through the opening 116 to outside the housing 110 (FIG. 5). Each conveyor 114 defines a starting end 171 outside of the cooking chamber for loading of food items, and a finishing end 173 for delivering food items to a return channel 175. A continuous, or endless, belt 172 engages with the rollers 168 and 170 to form a loop with an upper conveying portion 174, which conveys food items 120, and a lower return portion 176 below and generally parallel to the conveying portion 174. Any type of continuous or endless belt, which are well known to those skilled in the art, can be used in the present invention. A conveyor motor 154 engages one of rollers 168 and 170, preferably the entrance roller 168, and rotates the roller 168, which in turn advances the belt 172 in a continuous loop about the rollers 168 and 170. The speed of the belt 172 is determined by the speed of the motor 154, which is controlled by the control panel 130.

The paddle 180 includes a base 182, side panels 184, and a rear guard panel 188. A handle 190 attaches to the rear guard panel 188, such as with fasteners 186. Food is placed on the base 182 to support transfer of food items to and from the conveyors 114, and to prevent food items from falling into the return channel 175. For example, the paddle 180 can be used when melting cheese onto a food item. Otherwise, the cheese could be damages when the food item falls down the return channel 175. The side panels 184 prevent the food items from sliding off the sides of the base 182. The rear guard panel 188 provides protection to the operator from the heat of the food items and the conveyor toaster 100.

In operation, the operator engages the control panel 130 and selects the cooking conditions desired for each conveyor 114. Using the paddle 180, The food items 120 are placed on the starting end 171 of the conveyor 114. As the conveyor 114 conveys the food items 120 through the cooking chamber 112, the food items 120 are cooked simultaneous with radiant energy from the infrared heating elements 122 and 124 and convection heat from the circulating heated air circulated. The blower assembly 128 draws air over and around the heating elements 122 and 124 by the force of the fan 136 to heat the air to a desired temperature. Also, the blower assembly 128 forces the air through the impingement panels 162 to impinge the food items 120 with jets of heated air. The food advances to the finishing end 173 of the conveyor 114 and drops into the return channel 175 where it can be retrieved by the operator.

Having all the heating elements 122 and 124 located within the cooking chamber 112 reduces the thermal inefficiencies of the oven 100, of the cooking chamber 112, and also removes a restriction from the circulation duct 134. In addition, the lives of the blower motor 152 and electrical components 150 are extended due to the reduction in exposure to high temperatures.

In an alternative embodiment, a sensor for air temperature control is located in the cooking chamber 112, preferably above the heating elements 122 and 124. This location allows sensing of air that has passed over the elements 122 and 124 and been mixed in the fan 136. Moreover, there is no direct infrared energy from the heating elements 122 and 124 to affect the accuracy. This arrangement allows the sensor to acquire an accurate temperature of the air within the cooking chamber 112.

Changes can be made in the above constructions without departing from the scope of the invention, it is intended that all matter contained in the above description or shown in the accompanying drawings shall be interpreted as illustrative and not in a limiting sense.

What is claimed is:

1. A conveyor toaster, comprising:
a housing having a cooking chamber, a circulation duct in communication with the cooking chamber;
a first conveyor for conveyance of food items through the cooking chamber;
a first radiant heating element disposed within the toasting chamber for emitting radiant energy to the food items;
a fan assembly engaged with a blower motor, the fan assembly being disposed within the circulation duct for circulating heated air through the circulation duct and the cooking chamber; and
a process control device operatively connected to the first conveyor and the first radiant heating element, to operate a plurality of cooking conditions in the cooking chamber.

2. The conveyor toaster of claim 1, further comprising a second conveyor for conveyance of food items through the cooking chamber; and
wherein a speed of the first conveyor and a speed of the second conveyor are independently adjustable from each other.

3. The conveyor toaster of claim 1, wherein the radiant heating element is configured for emission of radiant energy from above the food items; and further comprising, a second radiant heating element positioned for emission of radiant energy from below the food items.

4. The conveyor toaster of claim 1, wherein a rate of heat emission of the first radiant heating element and a rate of heat emission of the second radiant heat element is independently adjustable from each other.

5. The conveyor toaster of claim 1, wherein the fan assembly enhances the cooking of food items by forced impingement convection.

6. The conveyor toaster of claim 1, wherein the circulation duct and the cooking chamber form a generally continuous loop for air circulation.

7. The conveyor toaster of claim 1, further comprising:
a controls chamber defined by the housing; and
a cooling channel configured for communication of ambient air from outside the housing into the controls chamber.

8. The conveyor toaster of claim 1, further comprising, an impingement panel positioned generally above the conveyor.

9. The conveyor toaster of claim 1, wherein the first conveyor can operate in in a first direction for conveyance of food items into the cooking chamber, and a second direction for conveyance of food items out of the cooking chamber.

10. The conveyor toaster of claim 1, further comprising, a paddle configured for supporting the food item and for transfer of food items to and from the conveyor.

11. A conveyor toaster, comprising:
a housing having a cooking chamber, a circulation duct in communication with the cooking chamber;
a process control device;
a pair of conveyors for conveyance of food items through the cooking chamber, each conveyor operatively connected to the process control device for independent setting of a rate of speed for each conveyor;
a radiant heating element disposed within the toasting chamber for emission of radiant energy to the food items operatively connected to the process control device for setting of rate of heat emission; and
a fan assembly engaged with a blower motor, the fan assembly being disposed within the circulation duct for circulation of heated air through the circulation duct and the cooking chamber.

12. The conveyor toaster of claim 11 wherein a rate of heat emission of the first radiant heating element and a rate of heat emission of the second radiant heat element is independently adjustable from each other.

13. The conveyor toaster of claim 11, wherein the fan assembly enhances the cooking of food items by forced impingement convection.

14. The conveyor toaster of claim 11, further comprising:
a controls chamber defined by the housing; and
a cooling channel configured for communication of ambient air from outside the housing into the controls chamber.

15. The conveyor toaster of claim 11, wherein the first conveyor is configured for operation in a first direction for conveyance of food items into the cooking chamber, and a second direction for conveyance of food items out of the cooking chamber.

16. A method of cooking food items, comprising the steps of:
providing a conveyor toaster having:
a housing with a cooking chamber and a circulation duct in communication with the cooking chamber;
a first conveyor for conveyance of food items through the cooking chamber;
a first radiant heating element disposed within the toasting chamber for emission of radiant energy to the food items;
a fan assembly engaged with a blower motor, the fan assembly being disposed within the circulation duct for circulation of heated air through the circulation duct and the cooking chamber; and
a process control device operatively connected to the first conveyor and the first radiant heating element, for operation of a plurality of cooking conditions in the cooking chamber;
setting the process control device to a rate speed of the first conveyor;
setting the process control device to a rate of heat emission of the first radiant heat element.

17. The method of cooking food item of claim 17, further comprising the steps of:
providing a second conveyor for conveyance of food items through the cooking chamber; and
setting the process control device to a rate speed of the second conveyor.

18. The method of cooking food item of claim 17, further comprising the steps of:
providing a second radiant heating element disposed within the toasting chamber for emitting radiant energy to the food items; and
setting the process control device to a rate of heat emission of the first radiant heat element.

19. The method of cooking food item of claim 17, further comprising the steps of:
providing a controls chamber defined by the housing; and
providing a cooling channel that extends from the control chamber to an atmosphere outside the housing; and
communicating ambient air from outside the housing into the controls chamber.

20. The method of cooking food item of claim 17, further comprising the steps of:
conveying the food item into the cooking chamber with the first conveyor;
halting conveyance of the conveyor for a predetermined period of time with the food item positioned within the cooking chamber; and
conveying the food item out of the cooking chamber with the first conveyor.
